(19) United States
(12) Patent Application Publication
(10) Pub. No.: US 2015/0198446 A1
(43) Pub. Date: Jul. 16, 2015

(54) ATM AND CARD ACCEPTANCE LOCATIONS USING AUGMENTED REALITY METHOD AND APPARATUS

(71) Applicant: Mastercard International Incorporated, Purchase, NY (US)

(72) Inventors: Kristofer PEREZ, New York, NY (US); Pedro J. Chavarria, Hampton Bays, NY (US)

(73) Assignee: Mastercard International Incorporated, Purchase, NY (US)

(21) Appl. No.: 14/155,668

(22) Filed: Jan. 15, 2014

(51) Int. Cl. G01C 21/10; G06Q 20/34; G01C 21/20; G06Q 20/10

(52) U.S. Cl. CPC G01C 21/10; G06Q 20/1085; G06Q 20/34; G01C 21/20

(57) ABSTRACT

A system, method, and computer-readable storage medium configured to locate an automated teller machine (ATM) or indicate payment card acceptance by a vendor using augmented reality.

### BACKGROUND

1. Field of the Disclosure

Aspects of the disclosure relate in general to financial services. Aspects include an apparatus, system, method and computer-readable storage medium to locate an automated teller machine (ATM) or indicate payment card acceptance by a vendor using augmented reality.

2. Description of the Related Art

In modern times, payment cards are rapidly replacing cash to facilitate payments or other forms of financial transactions. A payment card is a card that can be used by a cardholder and accepted by a vendor or merchant to make a payment for a purchase or in payment of some other obligation. An example of a payment card includes a stored-value card (such as a transit card or gift card), credit card, debit card, automated teller machine card, or charge card. The payment card is generally used to pay an exact amount.

Payment cards are affiliated with payment networks, which are operational networks that enable monetary exchange between parties.

An automated teller machine, also known as an automated banking machine, cash machine, cashpoint, or cashline, is an electronic telecommunications device that enables the clients of a financial institution to perform financial transactions without the need for a cashier, human clerk or bank teller.

On most modern ATMs, customers identify themselves by inserting a plastic ATM card. Generally, an ATM card has an encoded stripe or is a plastic smart card with a chip that contains a unique card number and some security information, such as an expiration date or Card Verification Value (CVV). Customers then enter a personal identification number (PIN) to authenticate themselves.

Using an ATM, customers can access their bank accounts in order to make cash withdrawals, debit card cash advances, check their account balances, make deposits into their accounts, as well as purchase pre-paid mobile phone credit.

Augmented reality (AR) is a live, direct or indirect, view of a physical, real-world environment whose elements are augmented (or supplemented) by computer-generated sensory input such as sound, video, graphics or GPS data. As a result, the technology functions by enhancing one's current perception of reality.

### SUMMARY

Embodiments include an apparatus, method and computer-readable medium configured to locate an automated teller machines or payment card acceptance using augmented reality.

An augmented reality device includes a global positioning system (GPS) antenna, a gyroscope, a processor, and a display. The global positioning system antenna is configured to determine a location of the augmented reality device. The gyroscope is configured to determine a direction of the augmented reality device. The processor is configured to match the location of the augmented reality device with a transaction type and a database to determine a proximately located transaction location. The display is configured to indicate the proximately located transaction location on a display when the proximately located transaction location is in visual range of the augmented reality device, as determined by the direction of the augmented reality device. The display is further configured to indicate directions to the proximately located transaction location on the display when the proximately located transaction location is not in visual range of the augmented reality device.

In some embodiments, the transaction type is a payment card transaction, and the proximately located transaction location is a merchant.

In yet other embodiments, the transaction type is an automated teller machine transaction, and the proximately located transaction location is an automated teller machine.

### BRIEF DESCRIPTION OF THE DRAWINGS

FIG. 1 illustrates an embodiment of an apparatus to locate an automated teller machine or payment card acceptance using augmented reality.

FIG. 2 illustrates a block diagram of the apparatus to locate an automated teller machine or payment card acceptance using augmented reality.

FIG. 3 is a flowchart of a method to locate an automated teller machine using augmented reality.

FIG. 4 is a flowchart of a method to determine payment card acceptance by a vendor using augmented reality.

### DETAILED DESCRIPTION

One aspect of the disclosure includes the understanding that ATM cardholders would favor using conveniently located ATMs that charge lower fees.

Yet another aspect of the disclosure is the realization that augmented reality can be used by ATM cardholders to locate and evaluate options for nearby ATMs.

Another aspect of the disclosure is the understanding that cardholders may favor using vendors that accept particular payment cards. Consequently, augmented reality may be used by payment card holders to locate and evaluate payment card acceptance for nearby merchants.

Embodiments of the present disclosure include a system, apparatus, method, and computer-readable storage medium configured to locate an ATM or merchants/vendors that accept a payment card (or payment card network) using augmented reality.

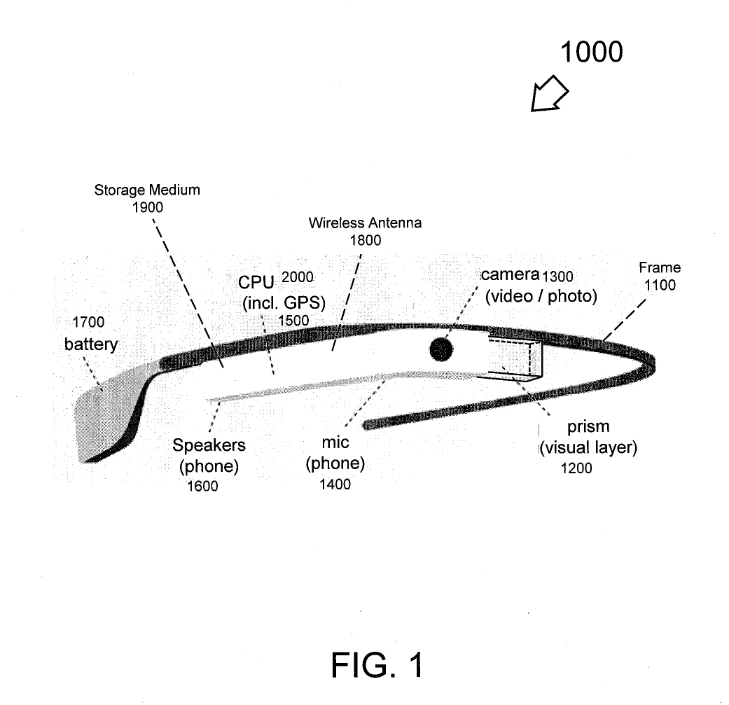

Embodiments will now be disclosed with reference to an exemplary embodiment of device 1000 of FIG. 1 configured to locate ATMs or payment card acceptance using augmented reality, constructed and operative in accordance with an embodiment of the present disclosure. It is understood by those familiar with the art that augmented reality devices may exist in a variety of different embodiments, including but not limited to: tablet computers, heads up displays, mobile phones, and augmented reality headsets. For the sake of example, this disclosure will describe an augmented reality headset 1000.

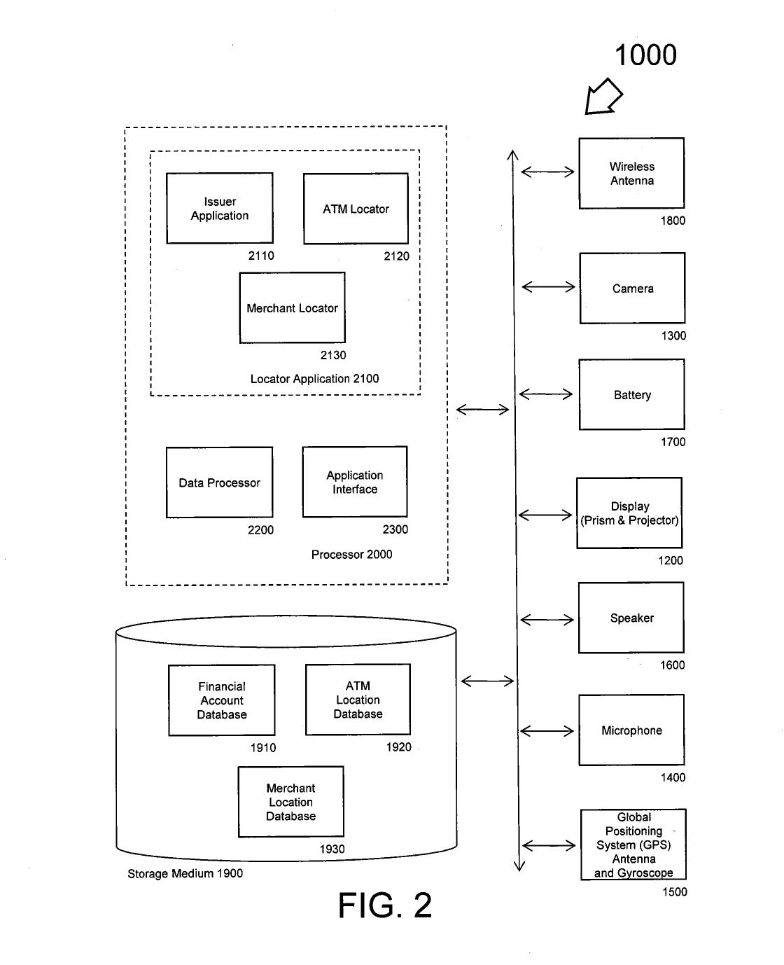

As shown in FIG. 1, the augmented reality headset 1000 includes a frame 1100. The frame may be made of a composite material, plastic, graphite, or other material known in the art. In some embodiments, frame 1100 includes touch sensors to provide touch pad functionality. Frame 1100 may house additional components, including a display (prism, visual layer) 1200, a camera 1300, microphone 1400, speakers 1600, battery 1700, global positioning system antenna and gyroscope 1500, processor 2000, storage medium 1900 and wireless antenna 1800. These components are described more fully with FIG. 2.

FIG. 2 illustrates a functional block diagram of the augmented reality headset 1000 configured to locate an ATM or payment card acceptance, constructed and operative in accordance with an embodiment of the present disclosure. As mentioned in FIG. 1, augmented reality headset 1000 has a frame 1100, which may house additional components.

Display 1200 provides visual information to the users. In some embodiments, the display is a piece of prism glass that allows users to see their environment, while providing a visual overlay on the environment.

Camera 1300 may be any image capture device known in the art. In some embodiments, camera 1300 may take pictures and record video which may be stored on a non-transitory computer-readable storage medium 1900 or downloaded via wireless antenna 1800.

Microphone 1400 may be any audio receiving device known in the art, including a bone conduction transducer.

Speakers 1600 may be any audio reproduction device known in the art.

Battery 1700 provides a power source to augmented reality headset 1000. In some embodiments, battery 1700 is a rechargeable lithium-ion battery.

Augmented reality headset 1000 may contain a 3-axis gyroscope, accelerometer, magnetometer (compass) and global positioning system antenna 1500 configured to determine the location of and direction that the user of the headset is looking at.

Storage medium 1900 may be a conventional read/write memory such as a flash memory, transistor-based memory, or other computer-readable memory device as is known in the art for storing and retrieving data.

In addition, as shown in FIG. 2, storage medium 1900 may also contain a financial account database 1910, an ATM location database 1920 and a merchant location database 1930. When present, financial account database 1910 is a data structure or database that contains a list of user payment or ATM card information, including issuer and the Primary Account Number (PAN) of the payment or ATM card. ATM location database 1920 is a database that stores the location of ATMs that are proximate (nearby) the user, or areas frequented by the user. Merchant location database 1930 is a database that stores the location of vendors or merchants that are proximate (nearby) the user, or areas frequented by the user, along with the payment cards accepted by each merchant. In most embodiments, proximate merchants, vendors, and ATMs will be located within a few blocks (or a mile) of the augmented reality headset 1000.

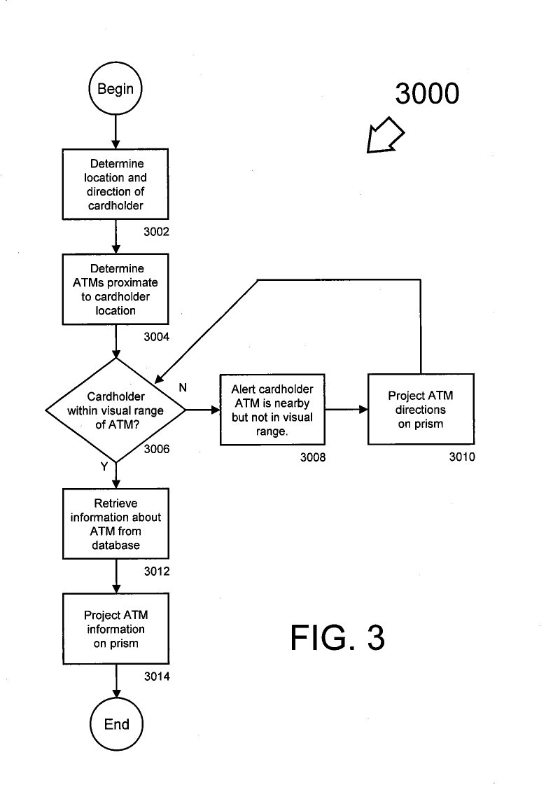

It is understood by those familiar with the art that one or more of these databases 1910-1930 may be combined in a myriad of combinations. The function of these structures may best be understood with respect to the flowcharts of FIG. 3, as described below.

Processor 2000 may be any central processing unit, microprocessor, micro-controller, computational device or circuit known in the art. It is understood that processor 2000 may temporarily store instructions and data in Random Access Memory (not shown).

As shown in FIG. 2, processor 2000 is functionally comprised of a locator application 2100, a data processor 2200, and application interface 2300.

A locator application 2100 enables the functionality for the consumer to locate and determine the characteristics of an automated teller machine. Locator application 2100 may further comprise: issuer application 2110, ATM locator 2120 and/or merchant locator 2130.

An issuer application 2110 is a program or service determines the transaction fees charged based on the issuer's agreement with the specific ATM owner. Additionally, issuer application 2110 determines whether a proximate merchant accepts a payment card. An issuer application 2110 receives the user's/cardholder's specific payment card information, such as issuer, ATM card number or payment card PAN. This information may be stored in a financial account database 1910. Issuer application 2110 may attempt to match the cardholder's ATM cards with ATM location database 1920.

ATM locator 2120 is a program or service that determines proximate ATM locations based on ATM location database 1920. In some embodiments, ATM locator 2120 periodically contacts an issuer with the augmented reality headset 1000 location, and downloads proximate ATM locations for storage in ATM location database 1920.

Merchant locator 2130 is a program or service that determines proximate merchant locations based on merchant location database 1930. In some embodiments, merchant locator 2130 periodically contacts an issuer with the augmented reality headset 1000 location, and downloads proximate merchant locations from a payment card issuer for storage in merchant location database 1930.

Data processor 2200 enables processor 2000 to interface with storage medium 1900, wireless antenna 1800, camera 1300, battery 1700, display 1200, speaker 1600, microphone 1400, global positioning system antenna and gyroscope 1500, computer memory or any other component not on the processor 2000. The data processor 2200 enables processor 2000 to locate data on, read data from, and write data to these components.

Application interface 2300 may be any user interface known in the art to facilitate communication with the user of the augmented reality headset 1000; as such, application interface 2300 may communicate with the user via display 1200, any touch sensor or button, speaker 1600, or microphone 1400.

These structures may be implemented as hardware, firmware, or software encoded on a computer readable medium, such as storage media 1900. Further details of these components are described with their relation to method embodiments below.

Wireless antenna 1800 may be any radio frequency (RF) transceiver as is known in the art for interfacing, communicating or transferring data across a telecommunications network, computer network, Bluetooth, WiFi, near-field communications, contactless point-of-sale network, and the like. Examples of such a network include a digital cellular telephony network. Antenna 1800 allows augmented reality headset 1000 to communicate via the digital cellular telephony network to an ATM card issuer, a payment network, or other entities.

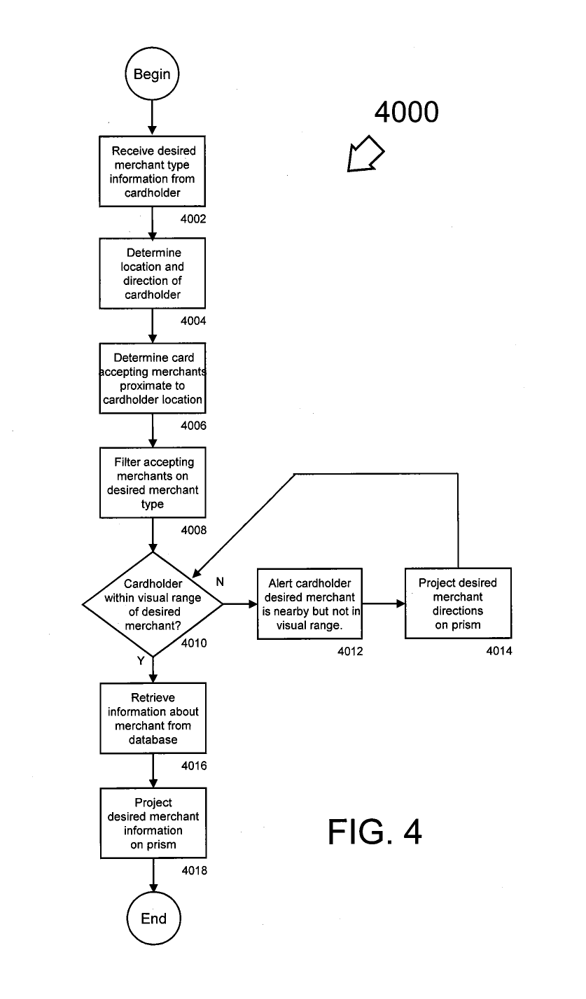

We now turn our attention to the method or process embodiments of the present disclosure described in the flow diagrams of FIGS. 3 and 4. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

FIG. 3 illustrates a flow chart of method 3000 to locate an automated teller machine using augmented reality device 1000, constructed and operative in accordance with an embodiment of the present disclosure.

Initially, at block 3002, processor 2000 determines the location and direction of the augmented reality device 1000 based on input from the global positioning system antenna 1500.

Based on the determined location and direction, ATM locator 2120 matches the location against automated teller machines stored in the ATM location database 1920, block 3004.

When the cardholder is not within visual range of an automated teller machine, as determined at decision block 3006, the cardholder is visually alerted that an automated teller machine is nearby, but not within visual range, block 3008. Directions to the nearby automated teller machines are projected on to the display 1200 by ATM locator 2120 in conjunction with application interface 2300, block 3010.

When the cardholder is within visual range of an automated teller machine, as determined at decision block 3006, ATM locator 2120 retrieves information about the automated teller machine from the ATM location database 1920 based on the ATM owner and/or the issuer of the cardholder's ATM card, block 3012. The retrieved information may include the ATM owner, hours of availability, payment networks supported, address of the automated teller machine, the fees charged by the automated teller machine, and maximum cash amount that may be withdrawn from the automated teller machine.

The retrieved information is projected on display 1200, block 3014.

FIG. 4 illustrates a flow chart of method 4000 to locate merchants that accept payment cards using augmented reality device 1000, constructed and operative in accordance with an embodiment of the present disclosure.

Initially, at block 4002, the user interface, i.e., application interface 2300 of the augmented reality device 1000 receives input of a desired merchant type from the user/cardholder.

Processor 2000 determines the location and direction of the augmented reality device 1000, and thus, the location of the user/cardholder, based on input from the global positioning system antenna 1500, block 4004.

Based on the determined location and direction, merchant locator 2130 matches the location against payment card-accepting merchants stored in the merchant location database 1930, block 4006. At block 4008, the merchants are filtered based on desired merchant type.

When the cardholder is not within visual range of the merchant, as determined at decision block 4010, the cardholder is visually alerted that a merchant is nearby, but not within visual range, block 4012. Directions to the desired merchant are projected on to the display 1200 by merchant locator 2130 in conjunction with application interface 2400, block 4014.

When the cardholder is within visual range of the merchant, as determined at decision block 4010, merchant locator 2130 retrieves information about the merchant from merchant location database 1930 based on the merchant and their acceptance of the cardholder's payment card, block 4016. The retrieved information may include name of the merchant, hours of operation, category of the merchant, the address of the merchant, and the type of payment cards accepted at the merchant. In some embodiments, the information may include the payment card network accepted.

The retrieved information is projected on display 1200, block 4018.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. An augmented reality device method comprising:
determining a location of the augmented reality device via a global positioning system (GPS) antenna;
determining a direction of the augmented reality device via a gyroscope;
matching, with a processor, the location of the augmented reality device with a transaction type and a database to determine a proximately located transaction location;
indicating the proximately located transaction location on a display when the proximately located transaction location is in visual range of the augmented reality device, as determined by the direction of the augmented reality device; and
indicating directions to the proximately located transaction location on the display when the proximately located transaction location is not in visual range of the augmented reality device.

2. The augmented reality device method of claim 1, wherein the database is retrieved over a data network.

3. The augmented reality device method of claim 2, wherein the database is stored on a non-transitory computer-readable storage medium.

4. The augmented reality device method of claim 3, wherein the matching further includes user payment card information.

5. The augmented reality device method of claim 4, wherein the transaction type is a payment card transaction, and the proximately located transaction location is a merchant.

6. The augmented reality device method of claim 4, wherein the transaction type is an automated teller machine transaction, and the proximately located transaction location is an automated teller machine.

7. The augmented reality device method of claim 6, further comprising:
indicating fees charged by the automated teller machine on the display.

8. An augmented reality device comprising:
a global positioning system (GPS) antenna configured to determine a location of the augmented reality device;
a gyroscope configured to determine direction of the augmented reality device;
a processor configured to match the location of the augmented reality device with a transaction type and a database to determine a proximately located transaction location; and
a display configured to indicate the proximately located transaction location on a display when the proximately located transaction location is in visual range of the augmented reality device, as determined by the direction of the augmented reality device, wherein the display is further configured to indicate directions to the proximately located transaction location on the display when the proximately located transaction location is not in visual range of the augmented reality device.

9. The augmented reality device of claim 8, further comprising:
a wireless antenna configured to retrieve the database over a data network.

10. The augmented reality device of claim 9, further comprising:
a non-transitory computer-readable storage medium configured to store the database.

11. The augmented reality device of claim 10, wherein the matching further includes user payment card information.

12. The augmented reality device of claim 11, wherein the transaction type is a payment card transaction, and the proximately located transaction location is a merchant.

13. The augmented reality device of claim 11, wherein the transaction type is an automated teller machine transaction, and the proximately located transaction location is an automated teller machine.

14. The augmented reality device of claim 13, wherein the display is further configured to indicate fees charged by the automated teller machine.

15. A non-transitory computer readable medium encoded with data and instructions, when executed by an augmented reality device the instructions causing the augmented reality device to:
determine a location of the augmented reality device via a global positioning system (GPS) antenna;
determine a direction of the augmented reality device via a gyroscope;
match, with a processor, the location of the augmented reality device with a transaction type and a database to determine a proximately located transaction location;
indicate the proximately located transaction location on a display when the proximately located transaction location is in visual range of the augmented reality device, as determined by the direction of the augmented reality device; and
indicate directions to the proximately located transaction location on the display when the proximately located transaction location is not in visual range of the augmented reality device.

16. The augmented reality device method of claim 15, wherein the database is retrieved over a data network.

17. The augmented reality device method of claim 16, wherein the database is stored on the non-transitory computer-readable storage medium.

18. The augmented reality device method of claim 17, wherein the matching further includes user payment card information.

19. The augmented reality device method of claim 17, wherein the transaction type is a payment card transaction, and the proximately located transaction location is a merchant.

20. The augmented reality device method of claim 19, wherein the transaction type is an automated teller machine transaction, and the proximately located transaction location is an automated teller machine.
